(19) United States
(12) Patent Application Publication
(10) Pub. No.: US 2026/0128627 A1
(43) Pub. Date: May 7, 2026

(54) Rotor for a Permanently Excited Electric Machine Comprising a Multipart Rotor Laminated Core and Bandage, Permanently Excited Electric Machine, and Method for Producing a Rotor

(71) Applicant: Bayerische Motoren Werke Aktiengesellschaft, Muenchen (DE)

(72) Inventors: Markus LANG, Muenchen (DE); Robert SCHMIDT, Muenchen (DE)

(21) Appl. No.: 19/118,892

(22) PCT Filed: Nov. 20, 2023
(86) PCT No.: PCT/EP2023/082379

§ 371 Date: Apr. 7, 2025

(30) Foreign Application Priority Data
Dec. 21, 2022 (DE) 10 2022 134 277.8

(51) Int. Cl. H02K 1/276; H02K 15/035

(52) U.S. Cl. CPC H02K 1/276; H02K 15/035

(57) ABSTRACT

A rotor includes a permanent magnet arrangement having permanent magnets for exciting a magnetic rotor flux, and a rotor laminated core for holding and channelling the flux and including axial magnet pockets distributed in the circumferential direction and in which the permanent magnets are arranged. The rotor laminated core includes a core partial laminated core that has first receiving regions for the permanent magnets distributed in the circumferential direction, and segment partial laminated cores are arranged on the outside of the core partial laminated core distributed in the circumferential direction and that, on an inside thereof, each have a second receiving region for the permanent magnets, wherein a first and second receiving region form a magnet pocket, and the rotor has a bandage surrounding the core for frictionally connecting segment partial laminated cores to the core partial laminated core, which at least temporarily contact one another in the connected state.

### BACKGROUND AND SUMMARY

The invention relates to a rotor for a permanently excited electric machine. The rotor has an embedded permanent magnet arrangement having a plurality of permanent magnets for exciting a magnetic rotor flux and a rotor laminated core for retaining and directing the magnetic rotor flux of the permanent magnet arrangement. The rotor laminated core comprises a plurality of axial magnet pockets which are arranged in a state distributed in the circumferential direction and in which the permanent magnets are arranged. The invention further relates to a permanently excited electric machine and a method for producing the rotor.

In this instance, interest is focused on permanently excited electric machines which are used in particular as traction machines for electrified motor vehicles, for example, electric or hybrid vehicles. Such permanently excited electric machines have a stator and a rotor which is rotatably supported with respect to the stator. The rotor has a rotor laminated core and a magnetic-flux-exciting permanent magnet arrangement. The permanent magnet arrangement may be an embedded or recessed permanent magnet arrangement in which the permanent magnets are arranged in axially extending magnet pockets of the rotor laminated core. The rotor laminated core is in this instance generally formed from a plurality of axially stacked, punched sheet metal slats. In order to form the magnet pockets for the permanent magnets, recesses are punched out of the sheet metal slats which when axially stacking the sheet metal slats are arranged in alignment with each other and in this instance form tunnel-like hollow spaces. In addition, additional recesses may be punched out of the sheet metal slats which, as a result of axial stacking and mechanical connection, for example, by bundling, of the sheet metal slats form air-filled cavities in the manner of hollow spaces. These cavities act as electromagnetic insulators and form flux direction portions in the rotor laminated core which are configured for selective direction of the magnetic rotor flux in the rotor laminated core and consequently are intended to reduce as far as possible or in the best case completely prevent undesirable dispersions and consequently losses in the rotor laminated core.

In and adjacent to the cavities, there may be arranged in the rotor laminated cores web regions which have a very small cross section and act as so-called flux barriers. Often the minimum width of these webs, as a result of the material properties of the rotor laminated core, for example, a strength, in particular under loading with centrifugal force, and for production-related reasons, for example, as a result of the punching tool and the bundling process, is limited so that a compromise has to be made in this instance with regard to the function thereof as flux barriers. For this reason, in known rotor laminated cores material, for example, in the form of webs, is often provided at locations at which in accordance with an optimal electromagnetic configuration it should be avoided since it has a detrimental effect on performance behavior or a performance of the electric machine.

An object of the present invention is to provide a high-performance, mechanically stable and electromagnetically improved, permanently excited electric machine.

This object is achieved according to the invention by a rotor, a permanently excited electric machine and a method having the features according to the present disclosure. Advantageous embodiments of the invention are also set out in the description and the Figures.

A rotor according to the invention for a permanently excited electric machine has an embedded permanent magnet arrangement having a plurality of permanent magnets for exciting a magnetic rotor flux. Furthermore, the rotor comprises a rotor laminated core for retaining and directing the magnetic rotor flux of the permanent magnet arrangement having a plurality of axial magnet pockets which are arranged in a state distributed in the circumferential direction and in which the permanent magnets are arranged. The rotor laminated core is configured in multiple pieces. To this end, the rotor laminated core has a core partial laminated core which at an outer side has a plurality of first receiving regions which are arranged in a state distributed in the circumferential direction for the permanent magnets. Furthermore, the rotor laminated core has a plurality of segment partial laminated cores which are arranged in a state distributed in the circumferential direction at the outer side of the core partial laminated core and which at an inner side in each case have at least one second receiving region for the permanent magnets. In this instance, a first and a second receiving region in each case form a magnet pocket. Furthermore, the rotor has a bandage which surrounds the multi-component rotor laminated core for non-positive-locking connection of the segment partial laminated cores to the core partial laminated core. In this instance, the core partial laminated core and the segment partial laminated cores touch each other at least temporarily in the connected state.

The invention further relates to a permanently excited electric machine for a motor vehicle having a stator and a rotor according to the invention which is rotatably supported with respect to the stator. The electric machine is used in particular as a drive machine for the motor vehicle so that it is in the form of an electrified motor vehicle. The permanently excited electric machine is an internal rotor machine in which the rotor is arranged in a state rotatably supported inside the stator. The stator may have a stator laminated core and stator windings which are retained by the stator laminated core and to which energy can be supplied in order to excite a magnetic stator flux.

The rotor has a plurality of rotor poles which are arranged adjacent to each other in the circumferential direction. Each rotor pole is in this instance associated with a sector of the in particular cylindrical rotor laminated core. The rotor laminated core is configured in multiple pieces and has the core partial laminated core and the segment partial laminated cores, wherein the partial laminated cores, that is to say the core partial laminated core and the segment partial laminated cores, are again releasably connected to form the rotor laminated core. For example, the rotor laminated core may have one segment partial laminated core per rotor pole. The partial laminated cores are here laminated cores which are separate from each other and which each have a large number of axially stacked laminated cores. The partial laminated cores are in this instance joined to form the rotor laminated core by the segment partial laminated cores being arranged in the circumferential direction radially at the outer side on the core partial laminated core. In the joined state of the partial laminated cores, with respect to a rotation axis of the rotor the core partial laminated core is thus arranged radially at the inner side and the segment partial laminated cores are arranged in the circumferential direction in a state distributed radially at the outer side. The core partial laminated core has in this instance in particular an axial through-opening through which a rotor shaft which extends along the rotation axis is guided and is connected in a rotationally secure manner to the core partial laminated core.

The core partial laminated core and the segment partial laminated cores have in this instance at radially facing faces or sides the receiving regions which in the joined state of the partial laminated cores are arranged at least in areas radially spaced apart from each other and thereby form the magnet pockets in the form of axial, tunnel-like hollow spaces. In this instance, at least one magnet pocket is formed in the rotor laminated core per rotor pole. The first receiving regions are in this instance formed by a contour path of the outer side or by an outer profile of the core partial laminated core and the second receiving regions are formed by contour paths of the inner sides or by inner profiles of the segment partial laminated cores. The receiving regions, in particular the first receiving regions of the core partial laminated core, may, for example, have groove-like, axially extending recesses which are arranged in the outer side of the core partial laminated core and in which the permanent magnets are partially arranged. The recesses may, for example, be formed by punching out indentations or notches in the sheet metal slats or by axially stacking the sheet metal slats. The receiving regions, in particular the second receiving regions of the segment partial laminated cores may have abutment faces or contact faces which are arranged in abutment against the permanent magnets and form covers for the groove-like recesses. The receiving regions surround the permanent magnets in such a manner that the permanent magnets are embedded or integrated in the rotor laminated core. The rotor laminated core thus has a non-salient pole geometry.

In order to provide the rotor laminated core with the permanent magnets, a sleeve-like auxiliary assembly member may be provided. The sleeve-like auxiliary assembly member and the core partial laminated core may be axially joined, for example, by the auxiliary assembly member being pushed or pulled axially onto the core partial laminated core. Subsequently, the permanent magnets and the segment partial laminated core are arranged or positioned on the core partial laminated core using the auxiliary assembly member. For example, the permanent magnets and the segment partial laminated cores are pushed axially into intermediate spaces which are formed between the outer side of the core partial laminated core and an inner side of the auxiliary assembly member. The permanent magnets are in this instance in particular not yet magnetized. In order to position the segment partial laminated cores in the auxiliary assembly member and consequently in order to correctly position the permanent magnets and the segment partial laminated cores on the core partial laminated core, outer sides of the segment partial laminated cores and the inner side of the auxiliary assembly member may have mutually corresponding, cooperating positioning elements.

The positioning elements of the segment partial laminated cores are in particular axial chamfers on the outer side of the segment partial laminated cores and the positioning elements of the auxiliary assembly member are in particular axial projections on which the chamfers are supported in the circumferential direction. For example, a segment partial laminated core may be arranged between two projections of the auxiliary assembly member so that chamfers, which are adjacent in the circumferential direction, of the segment partial laminated core are supported in the circumferential direction on two projections, which are adjacent in the circumferential direction, of the auxiliary assembly member. As soon as all the permanent magnets and segment partial laminated cores are arranged on the core partial laminated cores, the auxiliary assembly member is removed again, for example, axially removed or taken off, wherein the permanent magnets and the segment partial laminated cores remain on the core partial laminated core.

In order to mechanically connect the segment partial laminated cores to the core partial laminated core with the permanent magnets being enclosed, the bandage is provided. This is in particular a resilient element which in the state arranged on the rotor laminated core forms an interference fit assembly by which the segment partial laminated cores are pressed directly or indirectly by the permanent magnets against the core partial laminated core. The partial laminated cores are thereby connected in a non-positive-locking manner. As a result of the non-positive-locking connection produced by the bandage, the core partial laminated core and the segment partial laminated cores touch each other at least temporarily, that is to say, for example, in the stopped state and/or during operation of the electric machine. The bandage is cylindrical and may in this instance be configured in one piece or several pieces. In particular, the bandage has a fiber-reinforced, for example, carbon-fiber-reinforced plastics material. The bandage may consequently be a CFRP bandage with a particularly low weight. However, the bandage may also be formed from a different material. The bandage may, for example, be axially joined by being fitted, pushed or pulled over the rotor laminated core. In particular, the removal of the auxiliary assembly member and the fitting of the bandage are carried out simultaneously. In other words, both the auxiliary assembly member and the bandage are temporarily arranged on the rotor laminated core in order to prevent the rotor laminated core from disintegrating again. Whilst the auxiliary assembly member is thus removed or taken off via a first end face of the rotor laminated core, the bandage is already pulled on over an axially opposing second end face of the rotor laminated core. During the joining operation of the rotor, in addition two support and balancing disks can be arranged on the axially opposing end faces of the rotor laminated core. They may also be joined by the auxiliary assembly member.

In contrast to single-piece rotor laminated cores in which the magnet pockets or hollow spaces are surrounded by punching out at all sides laminated core material in the form of webs, the hollow spaces are formed in this instance by radially joining the partial laminated cores which are provided with the receiving regions. Consequently, stability-related and/or production-related webs or dimensions of the webs in the rotor laminated core at electromagnetically unfavorable locations can at least be reduced. This is also accompanied by a weight reduction of the rotor so that a performance of the electric machine can advantageously be increased. Furthermore, the rotor can be disassembled again in a particularly simple manner by removing the bandage. In particular, the permanent magnets can thereby be removed from the rotor laminated core again and recycled so that the electric machine is in addition configured in a particularly sustainable manner.

In one embodiment of the rotor, there is provision for the core partial laminated core to have per rotor pole a first receiving region with two groove-like recesses which are arranged in a V-shape, wherein the groove-like recesses with a V-shaped magnet pocket being formed per rotor pole are covered in each case by a segment partial laminated core. For example, each segment partial laminated core may have a second receiving region with two contact faces or covering faces which are arranged in a V-shape and which cover the groove-like recesses with the V-shaped magnet pocket being formed. As a result of the contact faces which are arranged in a V-shape, the segment partial laminated cores have, for example, a triangular-profile-like segment portion.

The V-shaped magnet pockets are in this instance in particular in the form of hollow spaces in which a region is configured without webs between the two permanent magnets in order to provide a cavity which reduces flux leakage. No laminated core material is thus arranged between the two permanent magnets, which are arranged in a V-shape, of a rotor pole. The region or free space which is located between the permanent magnets serves to reduce a magnetic flux leakage which may occur at edges or ends of permanent magnets. The rotor laminated core may have additional cavities which act as flux barriers or flux direction elements. They may be arranged in the core partial laminated core and/or the segment partial laminated cores and be formed by hole-like punched-out portions in the axially stacked and mechanically connected sheet metal slats of the respective partial laminated core.

There may be provision for the core partial laminated core to be configured in a star-shaped or ray-like manner. To this end, the core partial laminated core has radially outwardly projecting core part-teeth or core part-rays which delimit the first receiving regions in the circumferential direction and on which the segment partial laminated cores which are arranged in the circumferential direction are supported at least in areas and/or at least temporarily. The core part-teeth delimit the respective rotor poles at the pole edge and consequently have the q axis of the respective rotor pole. The d axis extends centrally with respect to the rotor poles, for example, between the two permanent magnets which are arranged in a V-shaped manner. In particular, core part-tooth flanks of the core part-teeth have the first receiving regions. For example, the core part-teeth flanks can extend obliquely and each have a groove-like recess. Per rotor pole, therefore, two permanent magnets are arranged in the mutually facing core part-tooth flanks of the core part-teeth on the pole edge. The core part-teeth further act as support elements for the segment partial laminated cores. For example, a segment partial laminated core is supported at least temporarily on two core part-teeth which are adjacent in the circumferential direction and fixed by the bandage.

For example, there may be provision for the segment partial laminated cores to each have at the edge a radially inwardly protruding segment portion which is arranged on an upper face of the core part-teeth and which is supported radially on the core part-teeth. The radially inwardly protruding segment portions form radial webs which are arranged, for example, via tangential segment portions in the form of tangential webs at both sides on the triangular-profile-like segment portion. Ends of the radial webs are arranged in abutment against the upper faces of the core part-teeth. In this instance, two adjacent segment partial laminated cores share a core part-tooth by the mutually adjacent radial webs of the two segment partial laminated cores being arranged beside each other on the upper face of a core part-tooth. The upper faces are in particular configured in a planar or non-curved manner. Preferably, the radially inwardly protruding segment portions of two adjacent segment partial laminated cores are arranged beside each other on the upper face of a core part-tooth with a tangential gap being formed, wherein an outer side of the rotor laminated core is formed by the outer sides of the segment partial laminated cores and the tangential gaps forming cavities which reduce flux leakage. The outer sides of the segment partial laminated cores are in particular configured in a curved manner so that the outer side of the rotor laminated core is configured in a cylindrical manner.

There may also be provision for the core part-teeth to have at both sides resilient tangential webs which protrude in the circumferential direction and for the segment partial laminated cores to have continuations which protrude tangentially at the edge. The continuations are in the connected state of the core partial laminated core and the segment partial laminated cores arranged in a radially overlapping manner with the resilient tangential webs with a respective radial gap being formed. The resilient tangential webs are arranged with flexible flux webs being formed by centrifugal-force-related radial redirection in abutment against the continuations and consequently close the radial gap at least temporarily and at least in areas. In particular in this instance, an outer side of the rotor laminated core is formed by an outer side of the segment partial laminated cores and by upper faces of the core part-teeth. The tangential webs of the core part-teeth may protrude from the core part-teeth flanks in the direction of the respective pole center and form together with the continuations flexible flux webs. In the non-deflected state of the tangential webs, the radial gap is at least partially formed between the tangential webs and the respective associated, overlapping continuation. For example, the segment partial laminated cores in the non-deflected state may be supported only on the permanent magnets and consequently by the bandage be connected in a non-positive-locking manner to the core partial laminated core via the permanent magnets. The segment partial laminated cores and the core partial laminated core thereby do not touch each other in the non-deflected state.

The radial gaps may at least locally close temporarily as a result of centrifugal force brought about by the redirection of the tangential webs. The magnetic flux can thereby flow via the leakage web which is formed and reduce the magnetic flux of the rotor. As a result of the centrifugal force, the proportion of the adjoining sheet portions may increase and consequently a larger leakage web may be formed. As a result of this concept, a weakening of the excitation of the rotor is brought about and less field weakening of the stator is required. A power loss of the electric machine at high speeds can thereby be reduced.

The embodiments set out with reference to the rotor according to the invention and the advantages thereof apply accordingly to the permanently excited electric machine according to the invention and to the method according to the invention.

Other features of the invention will be appreciated from the claims, the Figures and the description of the Figures. The features and feature combinations mentioned in the description and the features and feature combinations mentioned below in the description of the Figures and/or shown in the Figures alone can be used not only in the combination set out in each case but also in other combinations or alone.

The invention will now be explained in greater detail with reference to a preferred exemplary embodiment and with reference to the drawings.

### BRIEF DESCRIPTION OF THE DRAWINGS

FIG. 1 shows a schematic, perspective illustration of a rotor for a permanently excited electric machine, FIG. 2 shows a perspective illustration of a first embodiment of a core partial laminated core of the rotor;

FIG. 3 shows a perspective illustration of a first embodiment of a segment partial laminated core of the rotor;

FIG. 4 shows a perspective illustration of a rotor shaft of the rotor;

FIG. 5 shows a perspective illustration of a permanent magnet of the rotor;

FIG. 6 shows a perspective illustration of a bandage of the rotor;

FIG. 7 shows a perspective illustration of support and balancing disks of the rotor;

FIGS. 8a, 8b, 8c, 8d, 8e, and 8f show assembly steps when assembling the rotor;

FIG. 9 shows a cross section through the rotor when assembling the rotor;

FIG. 10 shows an enlarged cut-out from the cross section according to FIG. 9;

FIG. 11 shows a front view of the rotor when assembling the rotor;

FIG. 12 shows an enlarged cut-out from the front view according to FIG. 11;

FIG. 13 shows a perspective illustration of a rotor laminated core with a second embodiment of the core partial laminated core and the segment partial laminated cores; and

FIG. 14 shows a cross section through a rotor having a rotor laminated core according to FIG. 13.

### DETAILED DESCRIPTION OF THE DRAWINGS

In the Figures, elements which are identical and functionally identical are given the same reference numerals.

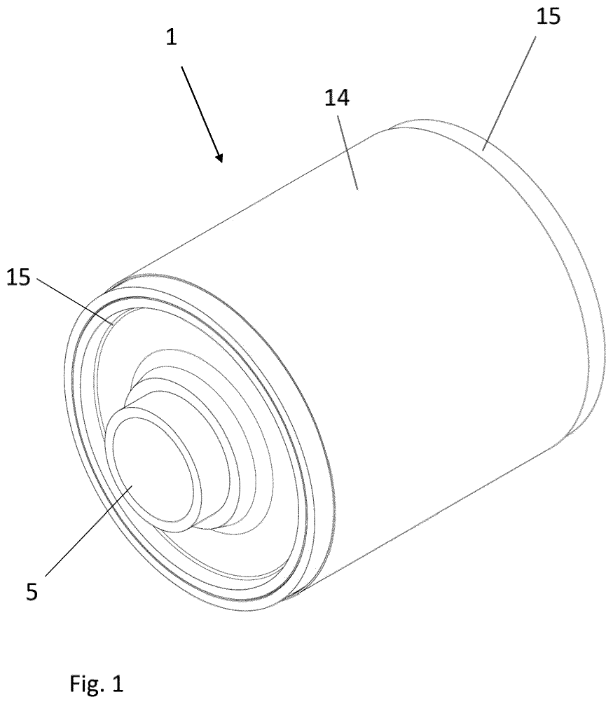

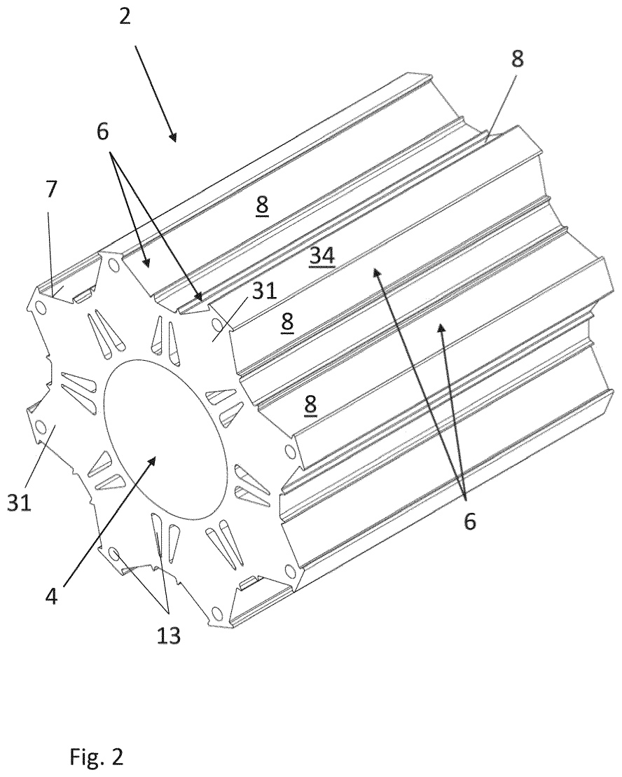

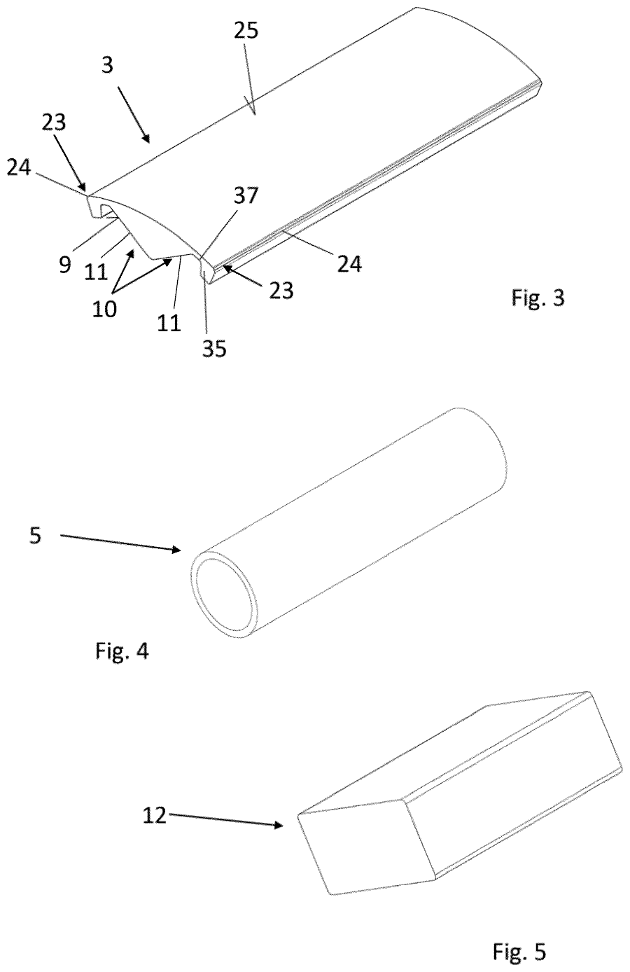

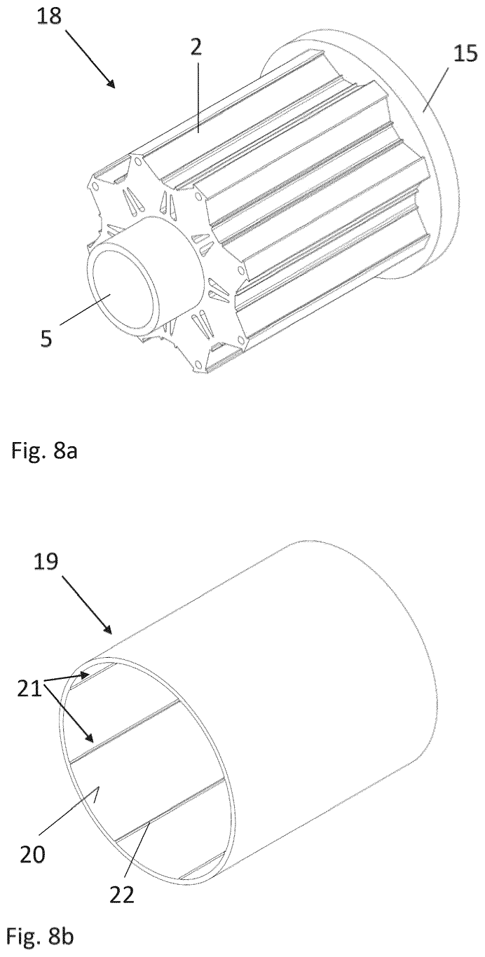

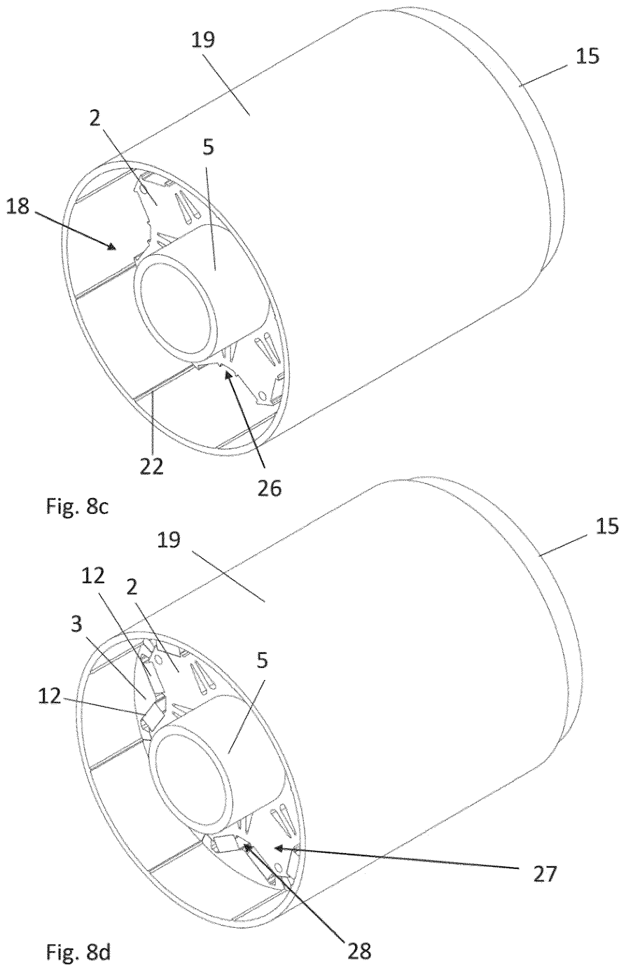

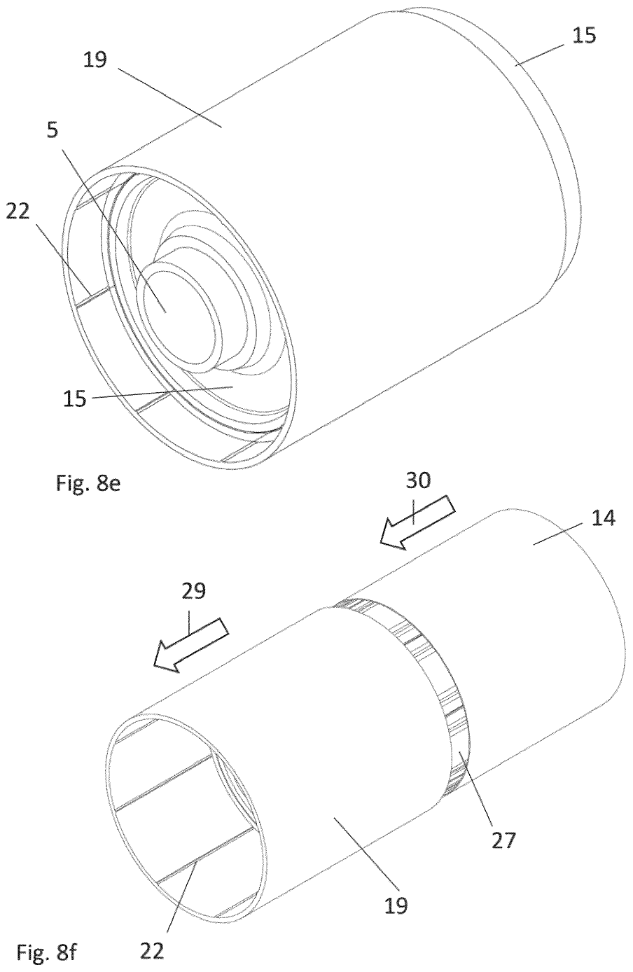

FIG. 1 shows a rotor 1 for a permanently excited electric machine which is used, for example, as a drive machine for an electrified motor vehicle. The rotor 1 has a multi-component rotor laminated core 27 (see FIG. 8d) which is composed of a core partial laminated core 2 and segment partial laminated cores 3. A first embodiment of a core partial laminated core 2 is shown in FIG. 2 and a first embodiment of a segment partial laminated core 3 is shown in FIG. 3. The core partial laminated core 2 has a passage 4 through which a rotor shaft 5 which is shown in FIG. 4 is guided and connected in a rotationally secure manner to the core partial laminated core 2. The core partial laminated core 2 further has per rotor pole a first receiving region 6 at an outer side 7, wherein the first receiving regions 6 are arranged in a state distributed in the circumferential direction. The first receiving regions 6 have in this instance per rotor pole two groove-like recesses 8 which are arranged in a V-shaped manner and which extend axially in the outer side 7 of the core partial laminated core 2. The segment partial laminated cores 3 have at the inner side 9 thereof in each case a second receiving region 10 which in this instance per rotor pole and consequently per segment partial laminated core 3 has two contact faces 11 which are arranged in a V-shape. The segment partial laminated core 3 consequently has a triangular-profile-like segment portion.

The first receiving regions 6 and the second receiving regions 10 form in the assembled state of the core partial laminated core 2 and the segment partial laminated cores 3 magnet pockets 28 (see FIG. 8d) for permanent magnets 12, of which one permanent magnet 12 is shown in FIG. 5 by way of example. The permanent magnets 12 are thus in each case enclosed in an axial magnet pocket 28 formed by a recess 8 and a contact face 11 and consequently embedded in the rotor laminated core 27. In order to direct the magnetic flux and/or in order to block the flux leakage portion of the magnetic flux of the permanent magnets 12, the core partial laminated core 2 may have additional cavities 13 which extend axially through the rotor laminated core 27. The cavities 13 may further serve to improve the resilient behavior in the core partial laminated core 2 of the assembled rotor laminated core 27.

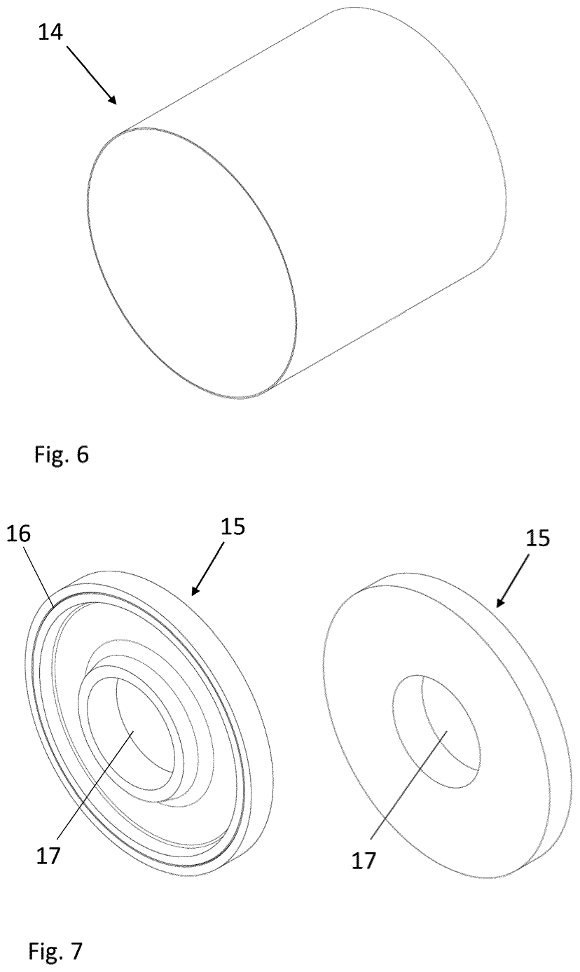

In order to mechanically connect the segment partial laminated cores 3 to the core partial laminated core 2, the rotor 1 has a bandage 14 which is shown by way of example in FIG. 6. The bandage 14 is in particular a CFRP bandage and configured in a cylindrical manner so that the bandage 14 can radially surround the cylindrical rotor laminated core 27. The bandage 14 and the segment partial laminated cores 3 which are arranged on the core partial laminated core 2 have with respect to each other an overdimension so that the segment partial laminated cores 3 are pressed against the core partial laminated core 2 directly or indirectly via the permanent magnets 12 which are arranged in the magnet pockets 28. By the bandage 14, consequently, a non-positive-locking connection or press-fit connection between the core partial laminated core 2 and the segment partial laminated cores 3 can be provided. Furthermore, the rotor 1 comprises two support and balancing disks 15 which are arranged at axially opposing end faces of the assembled rotor laminated core 27. The support and balancing disks 15 which are shown in FIG. 7, have, for example, circumferential recesses 16 in the form of annular grooves which act as auxiliary positioning members for a drill for introducing balancing bores. Furthermore, the support and balancing disks 15 have passages 17 for the rotor shaft 5 which is connected to the support and balancing disks 15.

FIGS. 8a to 8f show assembly steps when assembling the rotor 1. Initially, the core partial laminated core 2 and the rotor shaft 5 are joined and subsequently one of the support and balancing disks 15 is joined so that the sub-assembly 18 shown in FIG. 8 a is produced. Subsequently, a sleeve-like auxiliary assembly member 19 which is shown in FIG. 8b is provided. It has at an inner side 20 positioning elements 21 in the form of axial projections 22 which are arranged with spacing from each other in the circumferential direction. This auxiliary assembly member 19 is joined axially to the sub-assembly 18 so that the auxiliary assembly member 19 radially surrounds the sub-assembly 18, as shown in FIG. 8c.

Subsequently, the permanent magnets 12 and the segment partial laminated cores 3 are arranged by the auxiliary assembly member 19 on the core partial laminated core 2. To this end, the segment partial laminated cores 3 also have positioning elements 23 (see FIG. 3) which are in the form in this instance of chamfers 24 on the outer side 25 of the segment partial laminated cores 3. The permanent magnets 12 and the segment partial laminated cores 3 are in this instance in particular successively pushed into intermediate spaces 26 between the auxiliary assembly member 19 and the core partial laminated core 2, wherein the sub-assembly 18 can be rotated with the auxiliary assembly member 19 in the circumferential direction during the fitting operation. For example, the permanent magnets 12 can first be pushed axially into the recesses 8 of the rotor pole, which is at the apex, of the core partial laminated core 2. Subsequently, a segment partial laminated core 3 is axially pushed in in such a manner that the chamfers 24 of the segment partial laminated core 3 are supported in the circumferential direction at two adjacent projections 22 of the auxiliary assembly member 19 and consequently the segment partial laminated core 3 is guided between the projections 22 when it is pushed in. Subsequently, the auxiliary assembly member 19 can be rotated with the sub-assembly 18 so that a rotor pole, which is not yet fitted, of the core partial laminated core 2 is located at the apex and can subsequently be fitted. As a result of the arrangement of all the permanent magnets 12 and segment partial laminated cores 3 on the core partial laminated core 2, the rotor laminated core 27 which is shown in FIG. 8d is produced and has the axial magnet pockets 28 which are formed by the receiving regions 6, 10 of the partial laminated cores 2, 3 and which surround the permanent magnets 12.

Then, as shown in FIG. 8e, the second support and balancing disk 15 is pushed axially into the auxiliary assembly member 19 and arranged at the end face on the rotor laminated core 27. Subsequently, as shown in FIG. 8f, the auxiliary assembly member 19 is removed in a removal direction 29 from the rotor laminated core 27, whilst at the same time the bandage 14 is pulled in a joining direction 30 onto the rotor laminated core 27. The removal direction 29 and the joining direction 30 are in this instance orientated identically. After completely removing the auxiliary assembly member 19 and completely pulling on the bandage 14, the rotor 1 shown in FIG. 1 is formed.

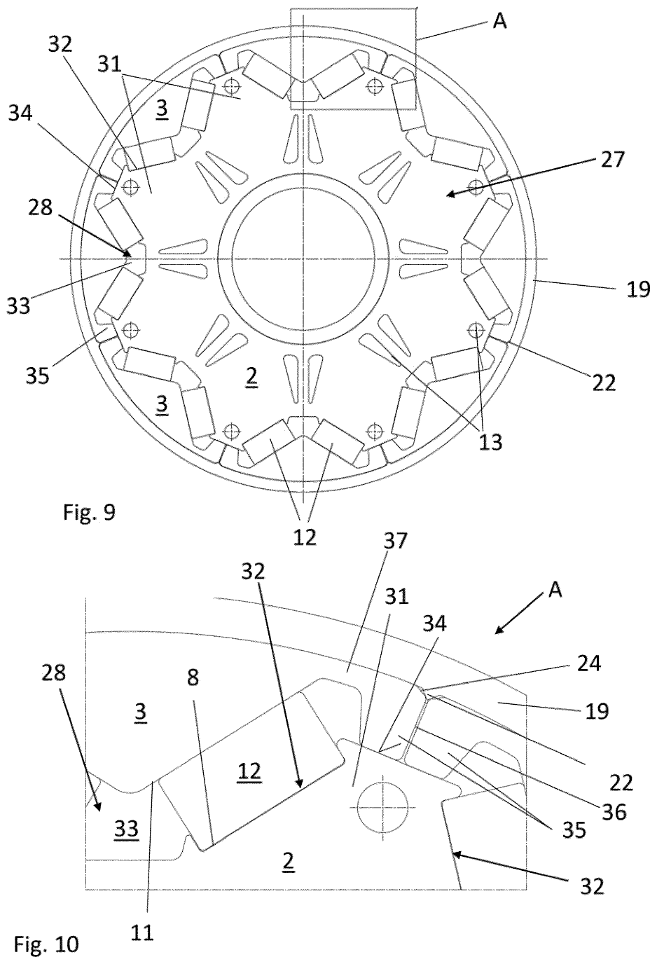

FIG. 9 shows a cross section through the rotor laminated core 27 which is provided with permanent magnets 12 and which is surrounded by the auxiliary assembly member 19. FIG. 10 shows an enlarged cut-out A from the cross section according to FIG. 9. The core partial laminated core 2 and the segment partial laminated cores 3 are in this instance configured according to the first embodiment illustrated in FIG. 2 and FIG. 3. The core partial laminated core 2 is configured in a star-shaped or ray-like manner and has a large number of core part-teeth 31 which are spaced apart from each other in the circumferential direction. Core part-tooth flanks 32 of the core part-teeth 31 have in each case one of the groove-like recesses 8. The core part-tooth flanks 32 extend in this instance obliquely so that per rotor pole two recesses 8 are arranged in a V-shape. The contact faces 11 of the segment partial laminated cores 3 are also arranged in a V-shaped manner so that the magnet pockets 28 are configured in a V-shaped manner and the permanent magnets 12 have a V-shaped arrangement in the rotor laminated core 27. Regions 33 of the magnet pockets 28 between the permanent magnets 12 are configured without webs so that the regions 33 form air-filled cavities for reducing flux leakage, in particular for preventing flux leakage.

The core part-teeth 32 further have in each case a planar axially and tangentially extending upper face 34 on which radially inwardly protruding segment portions 35 of the segment partial laminated cores 3 are arranged. In this instance, two radial segment portions 35 in the form of radial webs of two adjacent segment partial laminated cores 3 are arranged on the upper face 34 of a core part-tooth 31 so that an outer side of the rotor laminated core 27 is formed by the curved outer sides of the segment partial laminated core 3. The upper faces 34 form a contact region between the core partial laminated core 2 and the segment partial laminated cores 3. An excess dimension and a centering between the segment partial laminated cores 3 and the bandage 14 which has been subsequently joined and the resulting load path of the segment partial laminated cores 3 to the core partial laminated core 3 may be cushioned by the cavities 13 and consequently by the resilient behavior of the core partial laminated core 2.

In this case, the chamfers 24 which cooperate with the projections 22 of the auxiliary assembly member 19 are arranged at outer edges of the segment portions 35. Here, a radial gap 36 is formed between the segment portions 35 of the segment partial laminated cores 3 for tolerance compensation when assembling the rotor 1 and further acts as an electromagnetic insulator or flux barrier. Furthermore, tangential segment portions 37 in the form of tangential webs which serve to selectively guide the magnetic flux are arranged between the radial webs 35 and the contact faces 11 of a segment partial laminated core 3.

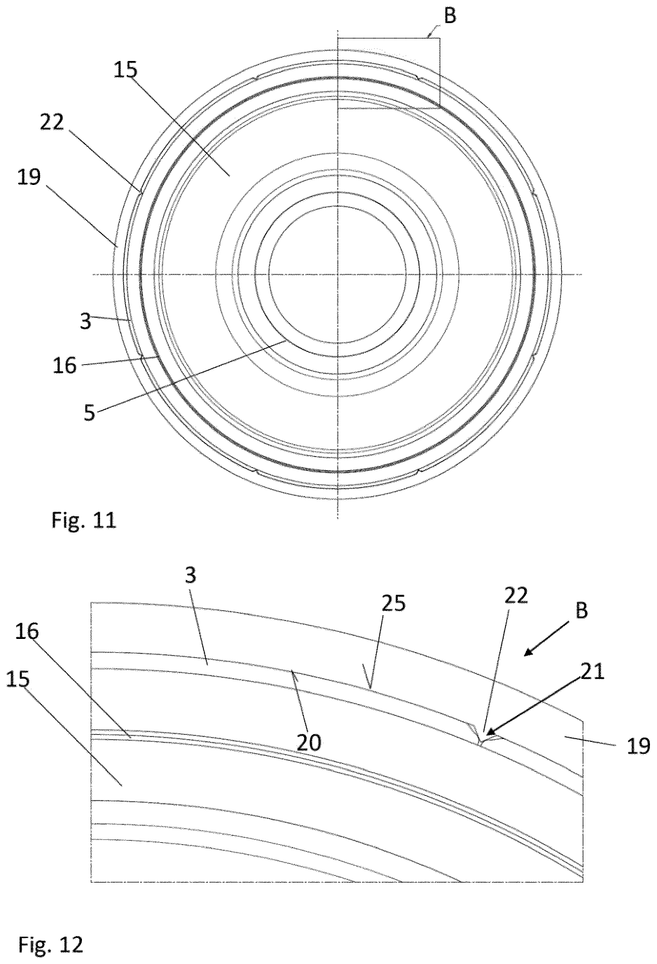

FIG. 11 shows a front view of the rotor laminated core 27 which is provided with the balancing and support disk 15 and which is surrounded by the auxiliary assembly member 19. FIG. 12 shows an enlarged cut-out B from the front view. In this instance, a clearance fit is provided between the outer side 25 of the segment partial laminated cores 3 and the inner side 20 of the auxiliary assembly member 19. Furthermore, an inner diameter of the auxiliary assembly member 19 is in the region of the positioning elements 21 greater than an outer diameter of the support and balancing disks 15. Consequently, the auxiliary assembly member 19 can after the joining of the support and balancing disk 15 be removed over the support and balancing disk 15 and the outer diameter thereof. An inner diameter of the bandage 14 which has been subsequently joined is greater than the outer diameter of both support and balancing disks 15. Consequently, the bandage 14 can be joined in a collision-free manner to the segment partial laminated cores 3 of the rotor laminated core 2 and at the same time over the support and balancing disks 15.

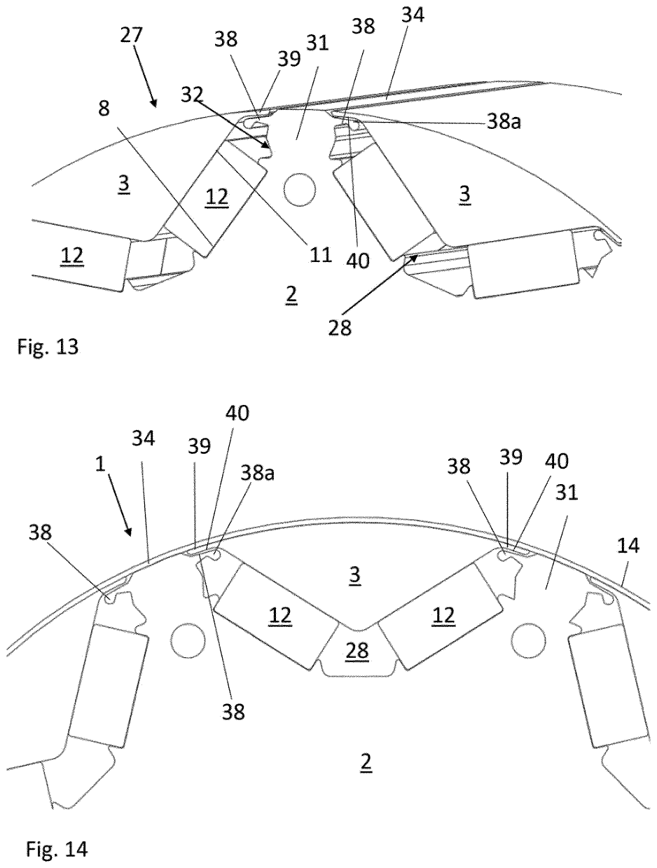

FIG. 13 shows as a perspective illustration a rotor laminated core 27 with a second configuration of the core partial laminated core 2 and the segment partial laminated cores 3. FIG. 14 shows a cross section cut-out through the rotor 1 with the rotor laminated core 27 according to FIG. 13. The core partial laminated core 2 is in this instance also configured in a star-shaped manner and has core part-teeth 31 which have resilient tangential webs 38 which protrude at both sides in the circumferential direction. The tangential webs 38 may under the influence of centrifugal force be deflected radially outward when the rotor 1 is rotated. To this end, the tangential webs 38 have at the end a weight-increasing upper region 38a. The tangential webs 38 are offset radially inward with respect to the upper face 34 of the core part-tooth 31 and arranged on the respective core part-tooth flanks 32. The segment partial laminated cores 3 have tangential continuations 39 which with a radial gap 40 being formed are arranged in a radially overlapping manner with the tangential webs 38. The tangential continuations 39 in this instance adjoin the triangular profile-like segment portion at both sides. In this instance, as a result of centrifugal force resulting from deflection of the associated tangential web 38 on the direction of the overlapping continuation 39, the radial gap 40 may be at least partially closed so that a flexible flux web is formed. The excess dimension of the partial laminated cores 2, 3 with respect to the bandage 14 and the radial gaps 40 between the tangential webs 38 and the continuations 39 are in this instance intended to be adjusted in such a manner that in the armature adjustment region of the electric machine a sufficient gap 40 is provided in order to allow the smallest possible flux leakage to flow over the tangential webs 38 and the continuations 39. The outer sides 25 of the segment partial laminated cores 3 and the in particular curved upper faces 34 form in this instance the outer side of the rotor laminated core 27 which is surrounded radially by the bandage 14.

1-13. (canceled)

14. A rotor for a permanently excited electric machine comprising:
an embedded permanent magnet arrangement comprising a plurality of permanent magnets configured to excite a magnetic rotor flux; and
a rotor laminated core configured to retain and direct the magnetic rotor flux of the permanent magnet arrangement and comprising a plurality of axial magnet pockets that are arranged in a state distributed in a circumferential direction and in which the permanent magnets are arranged,
wherein the rotor laminated core is configured in a plurality of pieces comprising:
a core partial laminated core that, at an outer side, comprises a plurality of first receiving regions that are arranged in a state distributed in the circumferential direction for the permanent magnets, and
a plurality of segment partial laminated cores that are arranged in a state distributed in the circumferential direction at the outer side of the core partial laminated core, and that, at an inner side in each case, have at least one second receiving region for the permanent magnets,
wherein a first and a second receiving region in each case form a magnet pocket, and
wherein the rotor has a bandage that surrounds the plurality of pieces of the rotor laminated core for non-positive-locking connection of the segment partial laminated cores to the core partial laminated core, wherein the core laminated core and the segment partial laminated cores touch each other at least temporarily in a connected state.

15. The rotor according to claim 14,
wherein the bandage comprises a fiber-reinforced plastics material.

16. The rotor according to claim 14,
wherein the core partial laminated core comprises, per rotor pole, a first receiving region with two groove-like recesses that are arranged in a V-shape, and which with a V-shaped magnet pocket being formed per rotor pole are covered in each case by a segment partial laminated core.

17. The rotor according to claim 16,
wherein the V-shaped magnet pockets are in a form of hollow spaces in which a region is configured without webs between the two permanent magnets in order to provide a cavity that reduces flux leakage.

18. The rotor according to claim 14,
wherein the core partial laminated core is configured in a star-shape and has radially outwardly protruding core part-teeth that delimit the first receiving regions in the circumferential direction and on which the segment partial laminated cores are at least temporarily supported.

19. The rotor according to claim 18,
wherein the segment partial laminated cores have, at an edge in each case, a radially inwardly protruding segment portion that is arranged on an upper face of the core part-teeth and which is supported radially on the core part-teeth.

20. The rotor according to claim 19,
wherein the radially inwardly protruding segment portions of two adjacent segment partial laminated cores with a tangential gap being formed are arranged beside each other on the upper face of a core part-tooth, wherein an outer side of the rotor laminated core is formed by outer sides of the segment partial laminated cores and the tangential gaps form cavities reducing flux leakage.

21. The rotor according to claim 18,
wherein the core part-teeth comprise, at both sides, resilient tangential webs that protrude in the circumferential direction,
wherein the segment partial laminated cores have continuations that protrude tangentially at the edge, wherein the continuations are, in a connected state of the core partial laminated core and the segment partial laminated cores with a radial gap being formed, arranged in a radially overlapping manner with the resilient tangential webs, and
wherein the resilient tangential webs are, with flexible flux webs being formed, arranged by centrifugal-force-related radial redirection, arranged in abutment against the continuations, and consequently close the radial gap at least temporarily and at least in areas.

22. The rotor according to claim 21,
wherein an outer side of the rotor laminated core is formed by an outer side of the segment partial laminated cores and by upper faces of the core part-teeth.

23. The rotor according to claim 14,
wherein the segment partial laminated cores comprise positioning elements comprising axially extending chamfers configured to position the segment partial laminated cores in a sleeve-like auxiliary assembly member.

24. A permanently excited electric machine for a motor vehicle, comprising:
a stator; and
the rotor according to claim 14, wherein the rotor is rotatably supported with respect to the stator.

25. A method for producing a rotor, comprising:
providing a core partial laminated core;
providing a sleeve-like auxiliary assembly member;
axially assembling the auxiliary assembly member and the core partial laminated core, wherein the sleeve-like auxiliary assembly member radially surrounds the core partial laminated core in an assembled state;
positioning permanent magnets and the segment partial laminated cores on the core partial laminated core by axially introducing the permanent magnets and the segment partial laminated cores into the auxiliary assembly member;
joining support and balancing disks at opposing end faces of the rotor laminated core;
removing the auxiliary assembly member; and
fitting a bandage to the rotor laminated core.

26. The method according to claim 25,
wherein removing the auxiliary assembly member from the rotor laminated core and the fitting the bandage to the rotor laminated core are carried out simultaneously.
